(19) United States
(12) Patent Application Publication
(10) Pub. No.: US 2003/0236316 A1
(43) Pub. Date: Dec. 25, 2003

(54) Foamed isocyanate-based polymer having improved toughness and process for production thereof

(75) Inventors: Jeffrey D. van Heumen, Guelph (CA); John A. Duley, King City (CA); Petar Pepic, Toronto (CA)

Correspondence Address: PATENT ADMINSTRATOR, KATTEN MUCHIN ZAVIS ROSENMAN, 525 WEST MONROE STREET, SUITE 1600, CHICAGO, IL, 60661-3693, US

(73) Assignee: Woodbridge Foam Corporation

(21) Appl. No.: 10/352,190

(22) Filed: Jan. 28, 2003

Related U.S. Application Data
(60) Provisional application No. 60/351,428, filed on Jan. 28, 2002.

(51) Int. Cl. C08G 18/00

(52) U.S. Cl. 521/155

(57) ABSTRACT

In one of its aspects, the invention relates to a foamed isocyanate-based polymer having a compression force deformation of greater than about 130 kPa at 10% deflection when measured pursuant to ASTM 1621 and a flexural displacement at yield of greater than about 5 mm when measured pursuant to ASTM D790-00. The present foamed polymer has a novel combination of hardness/stiffness and a flexibility.

### CROSS-REFERENCE TO RELATED APPLICATION

The present application claims the benefit under 35 U.S.C. §119(e) of provisional patent application S. No. 60/351,428, filed Jan. 28, 2002, the contents of which are hereby incorporated by reference.

### BACKGROUND OF THE INVENTION

1. Field of the Invention

In one of its aspects, the present invention relates to a foamed isocyanate-based polymer having a novel combination of hardness and flexibility properties. In another of its aspects, the present invention relates to a process for the production of such a foamed isocyanate-based polymer.

2. Description of the Prior Art

Isocyanate-based polymers are known in the art. Generally, those of skill in the art understand isocyanate-based polymers to be polyurethanes, polyureas, polyisocyanurates and mixtures thereof.

It is also known in the art to produce foamed isocyanate-based polymers. Indeed, one of the advantages of isocyanate-based polymers compared to other polymer systems is that polymerization and foaming can occur in situ. This results in the ability to mould the polymer while it is forming and expanding.

One of the conventional ways to produce a polyurethane foam is known as the “one-shot” technique. In this technique, the isocyanate, a suitable polyol, a catalyst, water (which acts as a reactive “blowing” agent and can optionally be supplemented with one or more physical blowing agents) and other additives are mixed together at once using, for example, impingement mixing (e.g., high pressure). Generally, if one were to produce a polyurea, the polyol would be replaced with a suitable polyamine. A polyisocyanurate may result from cyclotrimerization of the isocyanate component. Urethane modified polyureas or polyisocyanurates are known in the art. In either scenario, the reactants would be intimately mixed very quickly using a suitable mixing technique.

Another technique for producing foamed isocyanate-based polymers is known as the “prepolymer” technique. In this technique, a prepolymer is produced by reacting polyol and isocyanate (in the case of a polyurethane) in an inert atmosphere to form a liquid polymer terminated with reactive groups (e.g., isocyanate moieties and active hydrogen moieties). To produce the foamed polymer, the prepolymer is thoroughly mixed with a lower molecular weight polyol (in the case of producing a polyurethane) or a polyamine (in the case of producing a modified polyurea) in the presence of a curing agent and other additives, as needed.

Regardless of the technique used, it is known in the art to include a filler material in the reaction mixture. Conventionally, filler materials have been introduced into foamed polymers by loading the filler material into one or both of the liquid isocyanate and the liquid active hydrogen-containing compound (i.e., the polyol in the case of polyurethane, the polyamine in the case of polyurea, etc.). Generally, incorporation of the filler material serves the purpose of conferring so-called loaded building properties to the resulting foam product.

The nature and relative amounts of filler materials used in the reaction mixture can vary, to a certain extent, depending on the desired physical properties of the foamed polymer product, and limitations imposed by mixing techniques, the stability of the system and equipment imposed limitations (e.g., due to the particle size of the filler material being incompatible with narrow passages, orifices and the like of the equipment).

One known technique of incorporating a solid material in the foam product for the purpose of improving hardness properties involves the use of a polyol-solids dispersion, particularly one in the form of a graft copolymer polyol. As is known in the art, graft copolymer polyols are polyols, preferably polyether polyols, which contain other organic polymers. It is known that such graft copolymer polyols are useful to confer hardness (i.e., load building) to the resultant polyurethane foam compared to the use of polyols which have not been modified by incorporating the organic polymers. Within graft copolymer polyols, there are two main categories which may be discussed: (i) chain-growth copolymer polyols, and (ii) step-growth copolymer polyols.

Chain-growth copolymer polyols generally are prepared by free radical polymerization of monomers in a polyol carrier to produce a free radical polymer dispersed in the polyol carrier. Conventionally, the free radical polymer can be based on acrylonitrile or styrene-acrylonitrile (SAN). The solids content of the polyol is typically up to about 60%, usually in the range of from about 15% to about 40%, by weight of the total weight of the composition (i.e., free radical polymer and polyol carrier). Generally, these chain-growth copolymer polyols have a viscosity in the range of from about 2,000 to about 8,000 centipoise. When producing such chain-growth copolymer polyols, it is known to induce grafting of the polyol chains to the free-radical polymer.

Step-growth copolymer polyols generally are characterized as follows: (i) PHD (Polyharnstoff Disperion) polyols, (ii) PIPA (Poly Isocyanate Poly Addition) polyols, and (iii) epoxy dispersion polyols. PHD polyols are dispersions of polyurea particles in conventional polyols and generally are formed by the reaction of a diamine (e.g., hydrazine) with a diisocyanate (e.g., toluene diisocyanate) in the presence of a polyether polyol. The solids content of the PHD polyols is typically up to about 50%, usually in the range of from about 15% to about 40%, by weight of the total weight of the composition (i.e., polyurea particles and polyol carrier). Generally, PHD polyols have a viscosity in the range of from about 2,000 to about 6,000 centipoise. PIPA polyols are similar to PHD polyols but contain polyurethane particles instead of polyurea particles. The polyurethane particles in PIPA polyols are formed in situ by reaction of an isocyanate and alkanolamine (e.g., triethanolamine). The solids content of the PIPA polyols is typically up to about 80%, usually in the range of from about 15% to about 70%, by weight of the total weight of the composition (i.e., polyurethane particles and polyol carrier). Generally, PIPA polyols have a viscosity in the range of from about 4,000 to about 50,000 centipoise. See, for example, U.S. Pat. Nos. 4,374,209 and 5,292,778. Epoxy dispersion polyols are based on dispersions of cured epoxy resins in conventional based polyols. The epoxy particles are purportedly high modulus solids with improved hydrogen bonding characteristics.

Further information regarding useful graft copolymer polyols may be found, for example, in Chapter 2 of “Flexible Polyurethane Foams” by Herrington and Hock (1997) and the references cited therein.

Within the conventional isocyanate-based polymer foam art there are classes of foams conventionally referred to as rigid foam and semi-rigid foam. These foams typically are used in applications which require the foam to function in energy absorbing applications, automotive applications, appliance applications, structural applications and construction applications. In almost all cases, the rigid or semi-rigid PUF application is dictated by the achievable hardness/stiffness, which allows flexibility to be maintained to an allowable/desirable level. Also described as toughness, which is defined as the ability to bend without breaking. The ability to achieve extremely high hardness/stiffness is possible, but traditionally comes at the expense of the inherent flexibility of the material.

In rigid/semi-rigid PUF, hardness/stiffness can be achieved in one or more of the following three techniques:

1. Increased isocyanate index;

2. Incorporation of a high functionality low molecular weight polyhydroxy compounds (e.g., such a compound having a functionality of at least about 3 and a molecular weight of less than about 2000 g/mol); and

3. Incorporation of a solid-polyol dispersion such as a copolymer polyol (as described above).

Unfortunately, when high hardness/stiffness foams are produced using any these techniques, there is deterioration in the flexible properties of the foam. In a number of new rigid/semi rigid PUF applications, high hardness with high flexibility (also referred to in the art as “high toughness”) is a design requirement. Achieving these new design requirements is becoming increasingly difficult with the conventional methods of increasing foam hardness/stiffness

Thus, it would be highly desirable to have an isocyanate-based foam which has a combination of high hardness and high flexibility.

### SUMMARY OF THE INVENTION

It is an object of the present invention to provide a novel isocyanate-based polymer foam which obviates or mitigates at least one of the above-mentioned disadvantages of the prior art.

It is another object of the present invention to provide a novel isocyanate-based polymer foam.

It is yet another object of the present invention to provide a novel process for production of an isocyanate-based polymer foam.

Accordingly, in one of its objects, the present invention provides a foamed isocyanate-based polymer having a compression force deformation of greater than about 130 kPa at 10% deflection when measured pursuant to ASTM 1621 and a flexural displacement at yield of greater than about 5 mm when measured pursuant to ASTM D790-00.

In another of its aspects, the present invention provides a process for producing a foamed isocyanate-based polymer comprising the steps of:

contacting an isocyanate, an active hydrogen-containing compound, a dendritic macromolecule and a blowing agent to form a reaction mixture; and

expanding the reaction mixture to produce the foamed isocyanate-based polymer;

wherein:

(i) the reaction mixture is characterized by one or more of the following: an isocyanate index greater than about 110, the presence of a solids-polyol dispersion and the presence of a high functionality, low molecular weight polyhydroxy compound (e.g., such a compound having a functionality of at least about 3 and a molecular weight of less than about 2000 g/mol); and

(ii) at least a 15% by weight of the dendritic macromolecule may be mixed with a polyether polyol having an OH number less than about 40 mg KOH/g to form a stable liquid at 23° C.

In yet another of its aspects, the present invention provides an energy absorbing device comprising a foamed isocyanate-based polymer having a compression force deformation of greater than about 130 kPa at 10% deflection when measured pursuant to ASTM 1621 and a flexural displacement at yield of greater than about 5 mm when measured pursuant to ASTM D790-00.

In yet another of its aspects, the present invention provides a vehicular headliner comprising a foamed isocyanate-based polymer having a compression force deformation of greater than about 130 kPa at 10% deflection when measured pursuant to ASTM 1621 and a flexural displacement at yield of greater than about 5 mm when measured pursuant to ASTM D790-00.

As used throughout this specification, the term “isocyanate-based polymer” is intended to mean, inter alia, polyurethane, polyurea and polyisocyanurate. Further, the terms “dendritic polymer” and “dendritic macromolecule” are used interchangeably throughout this specification. These materials are generally known in the art. See, for example, any one of:

Tomalia et al in Angew. Chem. Int. Ed. Engl. 29 pages 138-175 (1990);

U.S. Pat. No. 5,418,301 [Hult et al (Hult)]; and

U.S. Pat. No. 5,663,247 [Sörensen et al (Sörensen)].

The present inventors have surprisingly and unexpectedly discovered that, by the introduction of a dendritic macromolecule into a formulation to produce rigid/semi-rigid isocyanate-based foam, it is possible to obviate or mitigate the known limitations on of increasing rigid/semi-rigid PUF hardness/stiffness while have good flexibility. More particularly, the present inventors have discovered a class of isocyanate-based foams having higher hardness/stiffness requirements without diminishing the flexibility performance. These novel foams may be achieved by introduction of a subset of dendritic macromolecules to foam formulations normally capable of producing a foam having high hardness/stiffness, but with low flexibility if the dendritic macromolecules are not present—i.e., a formulation characterized by one or more of the following:

an isocyanate index of at least about 110;

the presence of a high functionality low molecular weight polyhydroxy compounds (e.g., such a compound having a functionality of at least about 3 and a molecular weight of less than about 2000 g/mol); and

the presence of solids-polyol dispersion (as described above).

Preferably, the dendritic macromolecute is selected from a sub-group of dendritic macromolecules described in detail in U.S. provisional patent application 60/221,512 (filed on Jul. 28, 2000 and naming Pettersson et al. as inventors) and corresponding International Publication Number WO 02/10189 (filed in the name of Perstorp AB and published on Feb. 7, 2002).

Preferably, the dendritic macromolecule is characterized by the ability to mix at least about 15% by weight of the dendritic macromolecule with a polyether polyol having an OH number less than about 40 mg KOH/g to form a stable liquid at 23° C. As used throughout this specification, the term “stable liquid”, when used in connection with this solubility parameter of the dendritic macromolecule, is intended to mean that the liquid formed upon mixing the dendritic macromolecule and the polyol has a substantial constant light transmittance (transparent at one extreme and opaque at the other extreme) for at least 2 hours, preferably at least 30 days, more preferably a number of months, after production of the mixture. Practically, in one embodiment, the stable liquid will be in the form a clear, homogeneous liquid (e.g., a solution) which will remain as such over time. In another embodiment, the stable liquid will be in the form an emulsion of (at least a portion of) the dendritic macromolecule in the polyol which will remain as such over time—i.e., the dendritic macromolecule will not settle out over time.

### DETAILED DESCRIPTION OF THE PREFERRED EMBODIMENTS

The present invention is related to foamed isocyanate-based polymer and to a process for production thereof. Preferably, the isocyanate-based polymer is selected from the group comprising polyurethane, polyurea, polyisocyanurate, urea-modified polyurethane, urethane-modified polyurea, urethane-modified polyisocyanurate and urea-modified polyisocyanurate. As is known in the art, the term “modified”, when used in conjunction with a polyurethane, polyurea or polyisocyanurate means that up to 50% of the polymer backbone forming linkages have been substituted.

The present foamed isocyanate-based polymer preferably is produced from a reaction mixture which comprises an isocyanate comprising toluene diisocyanate, an active hydrogen-containing compound, a dendritic macromolecule and a blowing agent.

The isocyanate suitable for use in the reaction mixture is not particularly restricted and the choice thereof is within the purview of a person skilled in the art. Generally, the isocyanate compound suitable for use may be represented by the general formula:

Q(NCO)ᵢ

wherein i is an integer of two or more and Q is an organic radical having the valence of i. Q may be a substituted or unsubstituted hydrocarbon group (e.g., an alkylene or arylene group). Moreover, Q may be represented by the general formula:

Q¹-Z-Q¹

wherein Q¹ is an alkylene or arylene group and Z is chosen from the group comprising—O—, —O-Q¹-, —CO—, —S—, —S-Q¹-S— and —SO₂—. Examples of isocyanate compounds which fall within the scope of this definition include hexamethylene diisocyanate, 1,8-diisocyanato-p-methane, xylyl diisocyanate, (OCNCH₂CH₂CH₂OCH₂O)₂, 1-methyl-2,4-diisocyanatocyclohexane, phenylene diisocyanates, tolylene diisocyanates, chlorophenylene diisocyanates, diphenylmethane-4,4′-diisocyanate, naphthalene-1,5-diisocyanate, triphenylmethane-4,4′,4″-triisocyanate and isopropylbenzene-alpha-4-diisocyanate.

In another embodiment, Q may also represent a polyurethane radical having a valence of i. In this case Q(NCO)ᵢ is a compound which is commonly referred to in the art as a prepolymer. Generally, a prepolymer may be prepared by reacting a stoichiometric excess of an isocyanate compound (as defined hereinabove) with an active hydrogen-containing compound (as defined hereinafter), preferably the polyhydroxyl-containing materials or polyols described below. In this embodiment, the polyisocyanate may be, for example, used in proportions of from about 30 percent to about 200 percent stoichiometric excess with respect to the proportion of hydroxyl in the polyol. Since the process of the present invention may relate to the production of polyurea foams, it will be appreciated that in this embodiment, the prepolymer could be used to prepare a polyurethane modified polyurea.

In another embodiment, the isocyanate compound suitable for use in the process of the present invention may be selected from dimers and trimers of isocyanates and diisocyanates, and from polymeric diisocyanates having the general formula:

[Q″(NCO)ᵢ]ⱼ

wherein both i and j are integers having a value of 2 or more, and Q″ is a polyfunctional organic radical, and/or, as additional components in the reaction mixture, compounds having the general formula:

L(NCO)ᵢ

wherein i is an integer having a value of 1 or more and L is a monofunctional or polyfunctional atom or radical. Examples of isocyanate compounds which fall with the scope of this definition include ethylphosphonic diisocyanate, phenylphosphonic diisocyanate, compounds which contain a ═Si—NCO group, isocyanate compounds derived from sulphonamides (QSO₂NCO), cyanic acid and thiocyanic acid.

See also for example, British patent number 1,453,258, for a discussion of suitable isocyanates.

Non-limiting examples of suitable isocyanates include: 1,6-hexamethylene diisocyanate, 1,4-butylene diisocyanate, furfurylidene diisocyanate, 2,4-toluene diisocyanate, 2,6-toluene diisocyanate, 2,4′-diphenylmethane diisocyanate, 4,4′-diphenylmethane diisocyanate, 4,4′-diphenylpropane diisocyanate, 4,4′-diphenyl-3,3′-dimethyl methane diisocyanate, 1,5-naphthalene diisocyanate, 1-methyl-2,4-diisocyanate-5-chlorobenzene, 2,4-diisocyanato-s-triazine, 1-methyl-2,4-diisocyanato cyclohexane, p-phenylene diisocyanate, m-phenylene diisocyanate, 1,4-naphthalene diisocyanate, dianisidine diisocyanate, bitolylene diisocyanate, 1,4-xylylene diisocyanate, 1,3-xylylene diisocyanate, bis-(4-isocyanatophenyl)methane, bis-(3-methyl-4-isocyanatophenyl)methane, polymethylene polyphenyl polyisocyanates and mixtures thereof. A more preferred isocyanate is selected from the group comprising 2,4-toluene diisocyanate, 2,6-toluene diisocyanate and mixtures thereof, for example, a mixture comprising from about 75 to about 85 percent by weight 2,4-toluene diisocyanate and from about 15 to about 25 percent by weight 2,6-toluene diisocyanate. Another more preferred isocyanate is selected from the group comprising 2,4′-diphenylmethane diisocyanate, 4,4′-diphenylmethane diisocyanate and mixtures thereof. The most preferred isocyanate is a mixture comprising from about 15 to about 25 percent by weight 2,4′-diphenylmethane diisocyanate and from about 75 to about 85 percent by weight 4,4′-diphenylmethane diisocyanate.

If the process is utilized to produce a polyurethane foam, the active hydrogen-containing compound is typically a polyol. The choice of polyol is not particularly restricted and is within the purview of a person skilled in the art. For example, the polyol may be a hydroxyl-terminated backbone of a member selected from the group comprising polyether, polyester, polycarbonate, polydiene and polycaprolactone. Preferably, the polyol is selected from the group comprising hydroxyl-terminated polyhydrocarbons, hydroxyl-terminated polyformals, fatty acid triglycerides, hydroxyl-terminated polyesters, hydroxymethyl-terminated polyesters, hydroxymethyl-terminated perfluoromethylenes, polyalkyleneether glycols, polyalkylenearyleneether glycols and polyalkyleneether triols. More preferred polyols are selected from the group comprising adipic acid-ethylene glycol polyester, poly(butylene glycol), poly(propylene glycol) and hydroxyl-terminated polybutadiene—see, for example, British patent number 1,482,213, for a discussion of suitable polyols. Preferably, such a polyether polyol has a molecular weight in the range of from about 200 to about 10,000, more preferably from about 2,000 to about 7,000, most preferably from about 2,000 to about 6,000. Of course, the polyol used in the present process may be a polyol-solids dispersion (e.g., a graft copolymer polyol) of the type discussed hereinabove.

If the process is utilized to produce a polyurea foam, the active hydrogen-containing compound comprises compounds wherein hydrogen is bonded to nitrogen. Preferably such compounds are selected from the group comprising polyamines, polyamides, polyamines and polyolamines, more preferably polyamines. Non-limiting examples of such compounds include primary and secondary amine terminated polyethers. Preferably such polyethers have a molecular weight of greater than about 230 and a functionality of from 2 to 6. Such amine terminated polyethers are typically made from an appropriate initiator to which a lower alkylene oxide is added with the resulting hydroxyl terminated polyol being subsequently aminated. If two or more alkylene oxides are used, they may be present either as random mixtures or as blocks of one or the other polyether. For ease of amination, it is especially preferred that the hydroxyl groups of the polyol be essentially all secondary hydroxyl groups. Typically, the amination step replaces the majority but not all of the hydroxyl groups of the polyol.

The reaction mixture used to produce the present foamed isocyanate-based polymer typically will further comprise a blowing agent. As is known in the art water can be used as an indirect or reactive blowing agent in the production of foamed isocyanate-based polymers. Specifically, water reacts with the isocyanate forming carbon dioxide which acts as the effective blowing agent in the final foamed polymer product. Alternatively, the carbon dioxide may be produced by other means such as unstable compounds which yield carbon dioxide (e.g., carbamates and the like). Optionally, direct organic blowing agents may be used in conjunction with water although the use of such blowing agents is generally being curtailed for environmental considerations. The preferred blowing agent for use in the production of the present foamed isocyanate-based polymer comprises water.

It is known in the art that the amount of water used as an indirect blowing agent in the preparation of a foamed isocyanate-based polymer is conventionally in the range of from about 0.5 to as high as about 40 or more parts by weight, preferably from about 1.0 to about 10 parts by weight, based on 100 parts by weight of the total active hydrogen-containing compound content in the reaction mixture. As is known in the art, the amount of water used in the production of a foamed isocyanate-based polymer typically is limited by the fixed properties expected in the foamed polymer and by the tolerance of the expanding foam towards self structure formation.

The reaction mixture used to produce the present foamed isocyanate-based polymer typically will further comprise a catalyst. The catalyst used in the reaction mixture is a compound capable of catalyzing the polymerization reaction. Such catalysts are known, and the choice and concentration thereof in the reaction mixture is within the purview of a person skilled in the art. See, for example, U.S. Pat. Nos. 4,296,213 and 4,518,778 for a discussion of suitable catalyst compounds. Non-limiting examples of suitable catalysts include tertiary amines and/or organometallic compounds. Additionally, as is known in the art, when the objective is to produce an isocyanurate, a Lewis acid must be used as the catalyst, either alone or in conjunction with other catalysts. Of course it will be understood by those skilled in the art that a combination of two or more catalysts may be suitably used.

In a preferred aspect of the present invention a dendritic macromolecule is incorporated in the present foamed isocyanate-based polymer. Preferably, the dendritic macromolecule has the following characteristics:

an active hydrogen content of greater than about 3.8 mmol/g, more preferably greater than about 4.0 mmol/g, even more preferably in the range of from about 3.8 to about 10 mmol/g; even more preferably in the range of from about 3.8 to about 7.0 mmol/g; even more preferably in the range of from about 4.0 to about 8.0 mmol/g; most preferably in the range of from about 4.4 to about 5.7 mmol/g;

an active hydrogen functionality of at least about 8; more preferably at least about 16; even more preferably in the range of from about 16 to about 70; even more preferably in the range of from about 18 to about 60; even more preferably in the range of from about 17 to about 35; most preferably in the range of from about 20 to about 30;

at least about 15%, more preferably from about 15% to about 50%, even more preferably from about 15% to about 40%, even more preferably from about 15% to about 30%, by weight of the dendritic macromolecule may be mixed with a polyether polyol having an OH number less than about 40, more preferably from about 25 to about 35, mg KOH/g to form a stable liquid at 23° C.

Further details on the dendritic macromolecule may be obtained from U.S. provisional patent application 60/221,512 (filed on Jul. 28, 2000 and naming Pettersson et al. as inventors) and corresponding International Publication Number WO 02/10189 (filed in the name of Perstorp AB and published on Feb. 7, 2002).

As will be clearly understood by those of skill in the art, it is contemplated that conventional additives in the polyurethane foam art can be incorporated in the reaction mixture created during the present process. Non-limiting examples of such additives include: surfactants (e.g., organo-silicone compounds available under the tradename L-540 Union Carbide), cell openers (e.g., silicone oils), extenders (e.g., halogenated paraffins commercially available as Cereclor S45), cross-linkers (e.g., low molecular weight reactive hydrogen-containing compositions), pigments/dyes, flame retardants (e.g., halogenated organo-phosphoric acid compounds), inhibitors (e.g., weak acids), nucleating agents (e.g., diazo compounds), anti-oxidants, and plasticizers/stabilizers (e.g., sulphonated aromatic compounds). The amounts of these additives conventionally used would be within the purview of a person skilled in the art.

The manner by which the active hydrogen-containing compound, isocyanate, blowing agent, dendritic macromolecule and catalyst are contacted in the first step of the present process is not particularly restricted. Thus, it is possible to preblend the components in a separate tank which is then connected to a suitable mixing device for mixing with the blowing agent and catalyst. Alternatively, it is possible to preblend the active hydrogen-containing compound (e.g., polyol) with the blowing agent, catalyst and other additives, if present, to form a resin. This resin preblend could then be fed to a suitable mixhead (high pressure or low pressure) which would also receive an independent stream of the isocyanate.

Once the active hydrogen-containing compound, isocyanate, blowing agent, dendritic macromolecule and catalyst have been contacted and, ideally, mixed uniformly, a reaction mixture is formed. This reaction mixture is then expanded to produce the present isocyanate-based polyurethane foam. As will be apparent to those of skill in the art, the process of the present invention is useful in the production of slabstock foam, molded articles and the like. The manner by which expansion of the reaction mixture is effected will be dictated by the type of foam being produced.

The product of the present process is a foamed isocyanate-based polymer derived from a reaction mixture comprising toluene diisocyanate, wherein the foam has a compression force deformation of at least about 130 kPa at 10% deflection when measured pursuant to ASTM 1621 and a flexural displacement at yield greater than about 5 mm when measured pursuant to ASTM D790-00.

Preferably, the foam has a compression force deformation of at least about 140 kPa at 10% deflection when measured pursuant to ASTM 1621, more preferably at least about 150 kPa at 10% deflection when measured pursuant to ASTM 1621, most preferably in the range of from about 150 to about 250 kPa at 10% deflection when measured pursuant to ASTM 1621.

Preferably, the foam has a flexural displacement at yield in the range of from about 5 mm to about 7 mm when measured pursuant to ASTM D790-00. More preferably, the foam has a flexural displacement at yield in the range of from about 5 mm to about 6 mm when measured pursuant to ASTM D790-00.

The Examples below illustrate the improvements created by the introduction of the dendritic macromolecule into the foam formulation. In all cases, the method by which rigid/semi-rigid polyurethane foam was prepared is the same and is described as follows. The polyhydroxy compounds (polyols, etc.), surfactants, catalysts, water and any other additives were pre-blended in a suitable container. The isocyanate and tin based catalysts were excluded from this mixture. The pre-blended mixture was then conditioned to a temperature of approximately 25° C. Separately, the isocyanate was dispensed into a suitable container. With the resin blend prepared and suitably conditioned, the tin catalyst was added and, using a conventional two-stream mixing technique, the isocyanate was added to the resin pre-blend and dispensed in another suitable mould to allow the rigid/semi-rigid foam to free rise. After 24 hours, the rigid/semi-rigid foam product was cut into the appropriate dimensions in order to perform the desired measurements as specified in ASTM D1621 and D790-00. This methodology will be referred to as the General Procedure.

In the Examples below the following materials were used:

HS100, a 45% solids content graft copolymer (SAN) polyol, commercially available from Bayer;

P975, rigid-type poyol, commercially available from BASF;

H310, a dendritic macromolecule commercially available from Perstorp;

718i, a base polyol, similar in characteristics to the carrier polyol used in HS100, commercially available from BASF;

L3812LV, a surfactant, commercially available from Witco OSi;

Water, indirect blowing agent;

Niax A-1, a blowing catalyst, commercially available from Witco OSi;

PolyCat T12, a catalyst, commercially available from Air Products; and

Papi 27, isoycanate (MDI), commercially available from Dow.

### EXAMPLES 1-4

In Examples 1-4, various foams were produced using the General procedure and the formulations set out in Table 1. In these Examples, isocyanate based foams were prepared having decreasing amounts of graft copolymer polyol (HS100) from 88 parts per hundred parts polyol (pphp) in Example 1 to 50 pphp in Example 4. To compensate for the expected loss in hardness/stiffness of the isocyanate based foam with decreasing amount of HS100, the dendritic macromolecule (H3100) was added in increasing amounts from 8 pphp in Example 2 to 17 pphp in Example 4. A polyether polyol, 718i, was added to maintain the overall level of polyhydroxy compounds in the formulation. The total H₂O in the formulation was 3.60 pphp.

The effect of the addition of the dendritic macromolecule to the isocyanate based foam is shown in Table 2.

It is evident from Table 2 that an approximate 100% increase in the compression force deformation (CFD) hardness was found with the incorporation of up to 14.64% H3100. Generally, the use of conventional techniques to increase hardness/stiffness in rigid/semi-rigid polyurethane foam causes a corresponding decrease in the flexible properties. Surprisingly, in Examples 1-4, as the CFD hardness increased with increasing amounts of the H310, the flexural displacement at yield was largely unaffected. Hence, it is clear that, with the use of a dendritic macromolecule such as H310, large increases in CFD hardness are possible while maintaining the flexibility of the foam almost constant.

### EXAMPLES 5-7

In Examples 5-7, various foams were produced using the General procedure and the formulations set out in Table 3—the formulation of Example 1 is also shown for comparative purpose. The foam properties are reported in Table 4 further support the inference that the introduction of a dendritic macromolecule causes an increase in the PUF hardness while flexibility is largely maintained.

### EXAMPLES 8-10

In Examples 8-10, various foams were produced using the General procedure and the formulations set out in Table 5. Example 8 represents a typical rigid/semi-rigid slabstock polyurethane foam. Example 9 represents the situation where 18 ppphp of the graft coploymer polyol HS100 are replaced by 8 pphp of the dendritic macromolecule H310 and 10 pphp of a polyether polyol similar in characteristics to the carrier polyether polyol used in HS100. Example 10 represents the case where 6 pphp of the rigid type polyether polyol, P975, is replaced with 6 pphp dendritic macromolecule (H310). The properties of the foam products are reported in Table 6. With reference to Table 6, it is evident in either the case where graft copolymer polyol or rigid-type polyol is reduced and replaced with a dendritic macromolecule (Examples 9 and 10), the CFD hardness is maintained comparable with the equivalent rigid/semi-rigid PUF in the absence of the dendritic macromolecule (Example 8). Surprisingly, the flexible performance of the rigid/semi-rigid based PUF is improved significantly over that of the equivalent product in the absence of the dendritic macromolecule.

While this invention has been described with reference to illustrative embodiments and examples, the description is not intended to be construed in a limiting sense. Thus, various modifications of the illustrative embodiments, as well as other embodiments of the invention, will be apparent to persons skilled in the art upon reference to this description. It is therefore contemplated that the appended claims will cover any such modifications or embodiments.

All publications, patents and patent applications referred to herein are incorporated by reference in their entirety to the same extent as if each individual publication, patent or patent application was specifically and individually indicated to be incorporated by reference in its entirety.

TABLE 1

Example

| Ingredient | 1 | 2 | 3 | 4 |
|---|---|---|---|---|
| HS100 | 88.00 | 70.00 | 60.00 | 50.00 |
| P975 | 12.00 | 12.00 | 12.00 | 12.00 |
| H310 | 0.00 | 8.00 | 12.60 | 17.00 |
| 718i | 0.00 | 10.00 | 15.40 | 21.00 |
| L3812LV | 1.80 | 1.80 | 1.80 | 1.80 |
| H₂O | 3.60 | 2.78 | 2.31 | 1.87 |
| Niax A-1 | 0.43 | 0.43 | 0.43 | 0.43 |
| T-12 | 0.08 | 0.08 | 0.08 | 0.08 |
| Total | 105.91 | 105.09 | 104.62 | 104.48 |
| Papi 27 | 87.04 | 93.18 | 96.68 | 100.06 |
| Index | 120 | 120 | 120 | 120 |
| % SAN | 37.39 | 29.97 | 25.81 | 21.53 |
| % H3100 | 0.00 | 6.85 | 10.84 | 14.64 |
| % H₂O | 3.40 | 3.43 | 3.44 | 3.44 |

TABLE 2

| | Density | | Flex. Disp. @ |
|---|---|---|---|
| Example | (kg/m³) | 10% CFD (kPa) | Yield (mm) |
| 1 | 33.2 | 122 | 6.87 |
| 2 | 36.0 | 194 | 6.77 |
| 3 | 37.0 | 220 | 7.04 |
| 4 | 38.1 | 237 | 6.65 |

TABLE 3

Example

| Ingredient | 1 | 5 | 6 | 7 |
|---|---|---|---|---|
| HS100 | 88 | 70 | 70 | 70 |
| P975 | 12 | 12 | 12 | 12 |
| H3100 (HBP) | 0 | 4 | 6 | 8 |
| 718I | 0 | 14 | 12 | 10 |
| L3812LV | 1.80 | 1.8 | 1.8 | 1.8 |
| H₂O | 3.60 | 3.59 | 3.39 | 3.18 |
| Niax A-1 | 0.43 | 0.43 | 0.43 | 0.43 |
| T-12 | 0.08 | 0.08 | 0.08 | 0.08 |
| Total | 105.91 | 105.90 | 105.70 | 105.49 |
| Papi 27 | 87.04 | 98.05 | 99.20 | 100.35 |
| Index | 120 | 120 | 120 | 120 |
| % SAN | 37.39 | 29.74 | 25.81 | 21.53 |
| % H3100 | 0.00 | 3.40 | 10.84 | 14.64 |
| % H₂O | 3.40 | 3.78 | 3.78 | 3.79 |

TABLE 4

| | Density | | Flex. Disp. @ |
|---|---|---|---|
| Example | (kg/m³) | 10% CFD (kPa) | Yield (mm) |
| 1 | 33.8 | 125 | 6.09 |
| 5 | 31.9 | 125 | 6.16 |
| 6 | 32.7 | 145 | 5.43 |
| 7 | 33.6 | 172 | 5.24 |

TABLE 5

| | Examples | | |
|---|---|---|---|
| Ingredient | 8 | 9 | 10 |
| HS100 | 88 | 70 | 88 |
| P975 | 12 | 12 | 6 |
| H3100 (HBP) | 0 | 8 | 6 |
| 718I | 0 | 10 | 0 |
| L3812LV | 1.80 | 1.80 | 2.00 |
| H₂O | 3.60 | 3.18 | 3.29 |
| Niax A-1 | 0.43 | 0.43 | 0.43 |
| T-12 | 0.08 | 0.08 | 0.10 |
| Total | 105.91 | 105.49 | 105.82 |
| Papi 27 | 87.04 | 100.35 | 90.10 |
| Index | 120 | 120 | 120 |
| % SAN | 37.39 | 29.86 | 37.42 |
| % H3100 | 0 | 6.83 | 5.10 |
| % H₂O | 3.40 | 3.77 | 3.68 |

TABLE 6

| | Density | | Flex. Disp. @ |
|---|---|---|---|
| Example | (kg/m³) | 25% CFD (kPa) | Yield (mm) |
| 8 | 33.8 | 95.8 | 7.26 |
| 9 | 31.9 | 111.3 | 8.81 |
| 10 | 32.7 | 98.8 | 8.84 |

What is claimed is:

1. A foamed isocyanate-based polymer having a compression force deformation of greater than about 130 kPa at 10% deflection when measured pursuant to ASTM 1621 and a flexural displacement at yield of greater than about 5 mm when measured pursuant to ASTM D790-00.

2. The foamed isocyanate-based polymer foam defined in claim 1, wherein the foam has a compression force deformation of at least about 140 kPa at 10% deflection when measured pursuant to ASTM 1621.

3. The foamed isocyanate-based polymer foam defined in claim 1, wherein the foam has a compression force deformation in the range of from about 150 to about 250 kPa at 10% deflection when measured pursuant to ASTM 1621.

4. The foamed isocyanate-based polymer foam defined in claims 1, wherein the foam has a flexural displacement at yield in the range of from about 5 mm to about 7 mm when measured pursuant to ASTM D790-00.

5. The foamed isocyanate-based polymer foam defined in claim 1, wherein the reaction mixture comprise an isocyante, an active hydrogen-containing compound, a dendritic macromolecule and a blowing agent.

6. The foamed isocyanate-based polymer foam defined in claim 5, wherein at least 15% by weight of the dendritic macromolecule may be mixed with a polyether polyol having an OH number less than about 40 mg KOH/g to form a stable liquid at 23° C.

7. The foamed isocyanate-based polymer foam defined in claim 5, wherein the reaction mixture is characterized by one or more of the following: an isocyanate index greater than about 110, the presence of a solids-polyol dispersion and the presence of a high functionality, low molecular weight polyhydroxy compound.

8. The foamed isocyanate-based polymer foam defined in claim 5, wherein:
(i) the reaction mixture is characterized by one or more of the following: an isocyanate index greater than about 110, the presence of a solids-polyol dispersion and the presence of a high functionality, low molecular weight polyhydroxy compound (e.g., such a compound having a functionality of at least about 3 and a molecular weight of less than about 2000 g/mol); and
(ii) at least a 15% by weight of the dendritic macromolecule may be mixed with a polyether polyol having an OH number less than about 40 mg KOH/g to form a stable liquid at 23° C.

9. The foamed isocyanate-based polymer foam defined in claim 5, wherein the reaction mixture comprises an isocyanate index greater than about 110.

10. The foamed isocyanate-based polymer foam defined in claim 5, wherein the reaction mixture comprises a solids-polyol dispersion.

11. A process for producing a foamed isocyanate-based polymer comprising the steps of:
contacting an isocyanate, an active hydrogen-containing compound, a dendritic macromolecule and a blowing agent to form a reaction mixture; and
expanding the reaction mixture to produce the foamed isocyanate-based polymer;
wherein:
(i) the reaction mixture is characterized by one or more of the following: an isocyanate index greater than about 110, the presence of a solids-polyol dispersion and the presence of a high functionality, low molecular weight polyhydroxy compound; and
(ii) at least a 15% by weight of the dendritic macromolecule may be mixed with a polyether polyol having an OH number less than about 40 mg KOH/g to form a stable liquid at 23° C.

12. The process defined in claim 11, wherein the isocyanate comprises a prepolymer.

13. The process defined in claim 11, wherein the isocyanate is selected from the group comprising 2,4-toluene diisocyanate, 2,6-toluene diisocyanate and mixtures thereof.

14. The process defined in claim 11, wherein the isocyanate is selected from the group comprising 2,4′-diphenylmethane diisocyanate, 4,4′-diphenylmethane diisocyanate and mixtures thereof.

15. The process defined in claim 11, wherein the isocyanate is selected from the group comprising 2,4′-diphenylmethane diisocyanate, 4,4′-diphenylmethane diisocyanate and mixtures thereof; and (ii) mixtures of (i) with an isocyanate selected from the group comprising 2,4-toluene diisocyanate, 2,6-toluene diisocyanate and mixtures thereof.

16. The process defined in claim 11, wherein the active hydrogen-containing compound is selected from the group comprising polyols, polyamines, polyamides, polyamines and polyolamines.

17. The process defined in claim 11, wherein the active hydrogen-containing compound comprises a polyol.

18. The process defined in claim 17, wherein the polyol comprises a polyether polyol.

19. The process defined in claim 11, wherein the blowing agent comprises water.

20. The process defined in claim 11, wherein dendritic macromolecule has the following characteristics:
(i) an active hydrogen content of greater than about 3.8 mmol/g;
(ii) an active hydrogen functionality of at least about 8; and
(iii) at least a 15% by weight of the dendritic macromolecule may be mixed with a polyether polyol having an OH number less than about 40 mg KOH/g to form a stable liquid at 23° C.

21. The process defined in claim 20, wherein from about 15% to about 30% by weight of the dendritic macromolecule may be mixed with a polyether polyol having an OH number less than about 40 mg KOH/g to form a stable liquid at 23° C.

22. The process defined in claim 20, wherein at least a 15% by weight of the dendritic macromolecule may be mixed with a polyether polyol having an OH number in the range of from about 25 to 35 mg KOH/g to form a stable liquid at 23° C.

23. The process defined in claim 20, wherein at least a 15% by weight of the dendritic, macromolecule may be mixed with a polyether polyol having an OH number in the range of from about 28 to 32 mg KOH/g to form a stable liquid at 23° C.

24. The process defined in claim 20, wherein the active hydrogen is present in the macromolecule in the form of one or more mercapto moieties.

25. The process defined in claim 20, wherein the active hydrogen is present in the macromolecule in the form of one or more primary amino moieties.

26. The process defined in claim 20, wherein the active hydrogen is present in the macromolecule in the form of one or more secondary amino moieties.

27. The process defined in claim 20, wherein the active hydrogen is present in the macromolecule in the form of one or more hydroxyl moieties.

28. The process defined in claim 20, wherein the active hydrogen is present in the macromolecule in the form of two or more of a mercapto moiety, a primary amino moiety, a secondary amino moiety and a hydroxyl moiety.

29. The process defined in claim 20, wherein the active hydrogen content of the macromolecule is in the range of from about 3.8 to about 10 mmol/g.

30. The process defined in claim 20, wherein the active hydrogen content of the macromolecule is in the range of from about 3.8 to about 7.0 mmol/g.

31. The process defined in claim 20, wherein the active hydrogen content of the macromolecule is in the range of from about 4.4 to about 5.7 mmol/g.

32. The process defined in claim 20, wherein the active hydrogen functionality in the macromolecule is in the range of from about 8 to about 70.

33. The process defined in claim 20, wherein the active hydrogen functionality in the macromolecule is in the range of from about 10 to about 60.

34. The process defined in claim 20, wherein the active hydrogen functionality in the macromolecule is in the range of from about 15 to about 35.

35. The process defined in claim 20, wherein the active hydrogen functionality in the macromolecule is in the range of from about 20 to about 30.

36. The process defined in claim 20, wherein from about 15% to about 50% by weight of the dendritic macromolecule may be mixed with a polyether polyol having an OH number less than about 40 mg KOH/g to form a stable liquid at 23° C.

37. The process defined in claim 20, wherein from about 15% to about 40% by weight of the dendritic macromolecule may be mixed with a polyether polyol having an OH number less than about 40 mg KOH/g to form a stable liquid at 23° C.

38. The process defined in claim 20, wherein the macromolecule has an inherently branched structure comprising at least one of an ester moiety, an ether moiety, an amine moiety, an amide moiety and any mixtures thereof.

39. The process defined in, claim 20, wherein the macromolecule has an inherently branched structure comprising primarily an ester moiety, optionally combined with an ether moiety.

40. The process defined in claim 20, wherein the macromolecule has an inherently branched structure comprising primarily an ether moiety, optionally combined with an ester moiety.

41. The process defined in claim 20, wherein the macromolecule has an inherently branched structure comprising primarily an ester moiety, optionally combined with an ether moiety.

42. The process defined in claim 38, wherein the macromolecule further comprises nucleus to which the inherently branched structure is chemically bonded.

43. The process defined in claim 38, wherein a plurality of inherently branched structures are chemically bonded to one another.

44. The process defined in claim 38, wherein the inherently branched structure further comprises at least one chain stopper moiety chemically bonded thereto.

45. The process defined in claim 38, wherein the inherently branched structure further comprises at least two different chain stopper moieties chemically bonded thereto.

46. The process defined in claim 38, wherein the inherently branched structure further comprises at least one spacing chain extender chemically bonded thereto.

47. The process defined in claim 46, wherein the spacing chain extender is monomeric.

48. The process defined in claim 46, wherein the spacing chain extender is polymeric.

49. An energy absorbing device comprising a foamed isocyanate-based polymer having a compression force deformation of greater than about 130 kPa at 10% deflection when measured pursuant to ASTM 1621 and a flexural displacement at yield of greater than about 5 mm when measured pursuant to ASTM D790-00.

50. A vehicular headliner comprising a foamed isocyanate-based polymer having a compression force deformation of greater than about 130 kPa at 10% deflection when measured pursuant to ASTM 1621 and a flexural displacement at yield of greater than about 5 mm when measured pursuant to ASTM D790-00.
